(19) United States
(12) Patent Application Publication
(10) Pub. No.: US 2025/0360889 A1
(43) Pub. Date: Nov. 27, 2025

(54) AIRBAG SYSTEM, CONTROL UNIT, AND CONTROL METHOD

(71) Applicants: Robert Bosch GmbH, Stuttgart (DE); Bosch Automotive Products (Suzhou) Co. Ltd., Suzhou (CN)

(72) Inventors: Yinan Tu, Suzhou (CN); Kexin Huang, Suzhou (CN); Dan Hong, Suzhou (CN); Ming Wu, Suzhou (CN); Yunlei Lv, Suzhou (CN); Min Wu, Suzhou (CN); Ning Zhu, Suzhou (CN)

(21) Appl. No.: 19/215,519

(22) Filed: May 22, 2025

(30) Foreign Application Priority Data
May 23, 2024 (CN) 2024 1064 5653.9

(51) Int. Cl. B60R 21/13; B60R 21/01; B60R 21/0132

(52) U.S. Cl. CPC B60R 21/13; B60R 21/0132; B60R 2021/01013; B60R 2021/01184; B60R 2021/0119; B60R 2021/01286; B60R 2021/138

(57) ABSTRACT

A control unit includes a communication module configured to receive a switch state configuration signal, which includes a configuration request for the switch state of the anti-rollover function suppression switch. The control unit further includes a judgment module configured to judge a validity of the switch state configuration signal, and a control module configured to control an ignition circuit associated with the anti-rollover function according to the switch state requested to be configured in the switch state configuration signal when it is determined that the switch state configuration signal is valid.

### TECHNICAL FIELD

The present invention relates generally to the field of vehicles. In particular, the present invention relates to an airbag system for a vehicle and its control units and control methods.

### BACKGROUND

Currently, vehicles are typically configured with an anti-rollover function to improve vehicle safety. However, in scenarios such as when a vehicle user is experiencing extreme sports in an off-road scenario, the vehicle user does not want to trigger the vehicle's anti-rollover function. As a result, the vehicle user expects that the anti-rollover function can be enabled or suppressed. However, in the prior art, there is no solution that selectively triggers the anti-rollover function of a vehicle.

### SUMMARY OF THE INVENTION

In this context, the present invention is intended to provide a solution that can meet the different needs of vehicle users for the anti-rollover function in different driving scenarios.

According to an example of one aspect of the present invention, an airbag control unit is provided, comprising: a communication module configured to receive a switch state configuration signal, which includes a configuration request for the switch state of the anti-rollover function suppression switch; a judgment module configured to judge the validity of the switch state configuration signal; and a control module configured to control an ignition circuit associated with the anti-rollover function according to the switch state requested to be configured in the switch state configuration signal when it is determined that the switch state configuration signal is valid.

According to an example of another aspect of the present invention, an airbag system for a vehicle is provided, comprising: a human-machine interface; an anti-rollover function suppression switch; and an airbag control unit as described above.

According to an example of yet another aspect of the present invention, a method for controlling an airbag system is provided, comprising: receiving a switch state configuration signal, which includes a configuration request for the switch state of the anti-rollover function suppression switch; judging the validity of the switch state configuration signal; and controlling an ignition circuit associated with the anti-rollover function according to the switch state requested to be configured in the switch state configuration signal when it is determined that the switch state configuration signal is valid.

An example of another aspect of the present invention provides a machine-readable storage medium having executable instructions stored thereon that, when executed, cause one or a plurality of processors to perform the method described above.

An example of another aspect of the present invention provides a computer program product having computer-executable instructions stored thereon that, when executed, cause one or a plurality of processors to perform the method described above.

The above gives an overview of the main aspects of the present invention in order to allow for a basic understanding of these aspects. This summary is not intended to describe the key or important elements of all aspects of the present invention, nor is it intended to limit the scope of any or all aspects of the present invention. The purpose of this overview is to provide some implementations of these aspects in a simplified form as a preamble to the detailed description given later.

### BRIEF DESCRIPTION OF THE DRAWINGS

The following detailed description in conjunction with the accompanying drawings will make the technical solution of the present invention clearer. It may be understood that these accompanying drawings are merely used for illustration purposes, but are not intended to limit the protection scope of the present disclosure.

FIG. 1 is a schematic block diagram of an airbag system according to one embodiment of the present invention.

FIG. 2 is a flow chart of a method for controlling an airbag system according to one embodiment of the present invention.

### DETAILED DESCRIPTION OF THE EMBODIMENTS

### Overview

Examples of the present invention relate to a control strategy based on the configuration of an anti-rollover function suppression switch, which enables the airbag system to operate in two different modes, allowing safety components such as airbags to be deployed or prohibiting safety components such as airbags from being deployed. This meets the different needs of vehicle users for the anti-rollover function in different driving scenarios, thus improving the user experience.

### Exemplary Systems

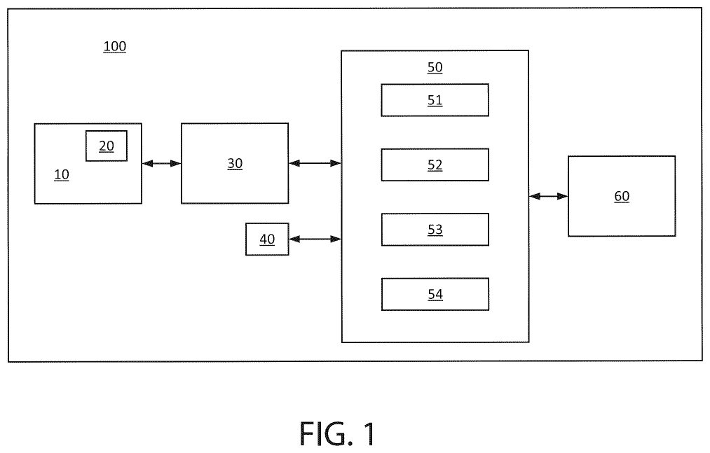

FIG. 1 shows an airbag system 100 according to one embodiment of the present invention, comprising: a human-machine interface (HMI) 10, anti-rollover function suppression switch 20, HMI control unit (HMI ECU) 30, indicator light 40, airbag control unit (ACU) 50, and ignition circuit 60.

The human-machine interface 10 is used to interact with the vehicle user. For example, the human-machine interface 10 is capable of receiving inputs from the vehicle user and providing a variety of information to the vehicle user. In one example, the human-machine interface 10 may be implemented as a touch screen, for example, by means of a central control screen of a vehicle. In this example, the vehicle user provides input to the human-machine interface 10 by operating (e.g., touching/tapping/double-tapping/sliding/dragging) interface elements (e.g., virtual buttons) on the interface, and the human-machine interface 10 presents interactive information to the vehicle user on the interface in one or more of text, icons, graphics, and tables. In addition, the human-machine interface 10 may also include a voice interface or voice-controllable interface elements. In other words, the human-machine interface 10 may interact with the vehicle user by voice. For example, an interface element or sub-interface that can be controlled by voice is presented on the human-machine interface 10 whereby one or more rounds of interaction with the vehicle user are conducted by voice to achieve the vehicle control desired by the vehicle user.

It should be noted that vehicle users may include, for example, vehicle drivers, testers and developers of vehicle functions, original equipment manufacturers (OEMs), and the like.

The anti-rollover suppression switch 20 (hereinafter referred to as switch 20) is a switch used to suppress or enable the anti-rollover function of the vehicle. The switch 20 has an ON state and an OFF state. When the switch 20 is in the ON state, the anti-rollover function of the vehicle is suppressed. In other words, when the switch 20 is in the ON state, even if the trigger condition for the anti-rollover function is met, the corresponding deployment operation will not be performed. For example, the airbag will not be deployed. When the switch 20 is in the OFF state, the anti-rollover function of the vehicle is enabled. In other words, when the switch 20 is in the OFF state, once the trigger condition of the anti-rollover function is met, the corresponding deployment operation will be performed. For example, the airbag will be deployed.

In one example, the switch 20 is implemented as an operable interface element (virtual button) on the human-machine interface 10. For example, a virtual button representing the switch 20 is presented on the human machine interface 10. The vehicle user configures the state of the switch 20 by providing input to the virtual button (i.e., the vehicle user operates/taps the virtual button), i.e., requests that the state of the switch 20 be switched to the ON state or the OFF state. For example, if the switch 20 is currently in the OFF state, the vehicle user taps the virtual button of the switch 20 once to indicate that the user requires to switch the state of the switch 20 to the ON state. If the switch 20 is currently in the ON state, the vehicle user taps the virtual button of the switch 20 once to indicate that the user requires to switch the state of the switch 20 to the OFF state.

In another example, the switch 20 may also be implemented as an operable physical switch. For example, the switch 20 is implemented as a physical button, a knob, or a lever.

In yet another example, the anti-rollover function suppression switch 20 may also be able implemented as a “smart switch” that is automatically configured according to the driving scenario, which may also be referred to as an “adaptive switch” or “scenario-sensing switch.”

In this example, the switch state configuration signal of the switch 20 is generated based on whether a signal representing a predetermined scenario is detected. For example, the autonomous driving system or driving assist system of the vehicle detects that the current driving scenario is one of one or more predetermined scenarios suitable for suppressing the anti-rollover function and generates a switch state configuration signal for configuring the switch 20 to the ON state. Similarly, if the autonomous driving system or driving assist system of the vehicle detects that the current driving scenario does not belong to any one of one or more predetermined scenarios suitable for suppressing the anti-rollover function, it generates a switch state configuration signal for configuring the switch 20 to the OFF state.

In addition, in this example, after generating the switch state configuration signal, information representative of the configuration state of the switch 20 may be presented on the human-machine interface 10, for example, by expressing to the vehicle user through text, symbols, or voice that the switch 20 will be configured to the ON state or the OFF state so that the vehicle user can confirm the configuration. In this way, vehicle safety can be further improved and the user experience can be improved through confirmation interaction with the vehicle user.

The HMI control unit 30 is capable of communicating with other control units of the vehicle (e.g., the airbag control unit 50). For example, the HMI control unit 30 sends a request signal based on vehicle user input to other control units of the vehicle and calculates, judges, or makes decisions based on control signals received from other control units. In one example, the HMI control unit 30 generates a switch state configuration signal according to the operation of the switch 20 by the vehicle user, which includes a configuration request by the vehicle user for the ON state or OFF state of the switch 20.

The indicator light 40 is used to present the current state of the switch 20. For example, the indicator light 40 presents whether the switch 20 is in the ON state or OFF state by different light colors or blinking patterns. In addition, the indicator light 40 is able to present a situation where the switch 20 is disabled or released from being disabled (i.e., configurable) by a particular light color or blinking pattern.

The airbag control unit 50 is capable of communicating with the HMI control unit 30 to receive a switch state configuration signal from the HMI control unit 30. In addition, the airbag control unit 50 judges the validity of the received switch state configuration signal. When the signal is judged to be valid, the ignition circuit associated with the anti-rollover function is controlled according to the switch state requested in the signal. When the signal is determined to be invalid, the ignition circuit associated with the anti-rollover function is controlled according to the switch state requested in the last valid switch state configuration signal in the current ignition cycle of the vehicle. In this way, the airbag control unit 50 may control whether safety components such as airbags are deployed. Specific embodiments of how the airbag control unit 50 performs this control process will be described in the method section below.

In one example, the airbag control unit 50 includes a communication module 51, a judgment module 52, a control module 53, and a vehicle event data recording module 54. It is to be understood that the nomenclature of these modules is functional and not intended to define their implementation or physical location. For example, these modules may be implemented on the same chip or circuit or may be implemented on different chips or circuits.

The airbag control unit 50 may be implemented by using hardware, software, or a combination of software and hardware. For hardware implementation, it can be implemented by one or more dedicated integrated circuits (ASICs), digital signal processors (DSPs), data signal processing devices (DSPDs), programmable logic devices (PLDs), field-programmable gate arrays (FPGAs), processors, controllers, microcontrollers, microprocessors, electronic units designed to perform their functions, or combinations thereof. For software implementation, it may be realized using microcode, program code, or code segments, and they may also be stored in machine-readable storage media such as storage components.

In one example, the airbag control unit 50 is implemented to include a memory and one or more processors. The memory includes instructions that, when executed by the one or more processors, implement a control method according to examples of the present invention.

The ignition circuit 60 includes an ignition circuit associated with the anti-rollover function of the vehicle, for example, an airbag ignition circuit. The ignition circuit may also include one or more of the following ignition circuits: seat belt (e.g., shoulder and lap belt) pretensioners, side curtain airbags, side impact airbags, and remote airbags. Because safety components such as airbags are usually disposable, they need to be replaced with new ones after being deployed. According to the control strategy of examples of the present invention, it is possible to suppress the deployment of safety components such as airbags in certain scenarios. Thus, in cases where safety components such as airbags do not need to be deployed, they will not be deployed, thereby eliminating the cost of replacing new safety components. Moreover, this situation can also enhance the user's driving experience because the user's extreme sports will not be interrupted by events such as airbag deployment.

### EXAMPLE METHODS

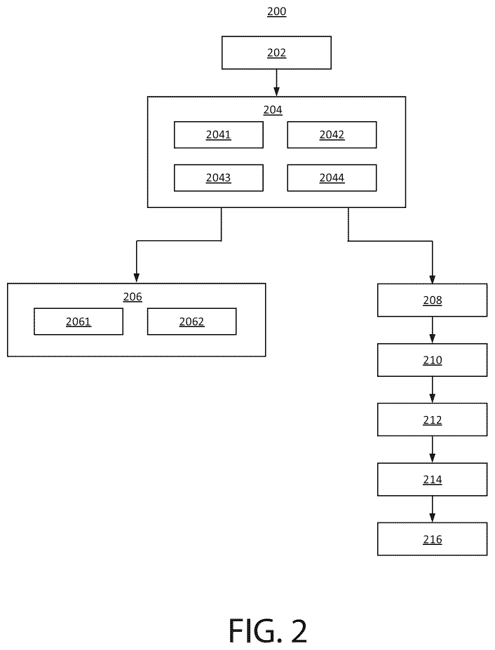

FIG. 2 shows schematically a method 200 for controlling an airbag system according to one embodiment of the present invention. The method 200 may be implemented by the airbag control unit 50 described above. The method 200 is described below with the airbag control unit 50 implementing the method 200 as an example.

Referring to FIG. 2, at block 202, the communication module 51 receives a switch state configuration signal from the HMI control unit 30. The switch state configuration signal includes a configuration request for the switch state of the anti-rollover function suppression switch 10, i.e., a request by the vehicle user to configure the state of the switch 10 to the ON or OFF state.

In block 204, the judgment module 52 judges the validity of the received switch state configuration signal. This validity judgment may include a plurality of judgments to judge the validity of the signal from a plurality of aspects (blocks 2041-2044). Furthermore, when the result of each judgment is affirmative, the signal is judged to be valid; when the result of at least one judgment is negative, the judgment is that the signal is invalid. Examples of various judgments are described below.

In one example, referring to block 2041, the judgment module 52 judges if the number of message frames (e.g., the number of frames of the CAN message included in the switch state configuration signal) corresponding to the received switch state configuration signal is greater than or equal to the frame number threshold. Here, the frame number threshold is predetermined. This frame number threshold may be set in the judgment module 52. Moreover, the frame number threshold may be adjusted according to user needs or specific application scenarios.

This judgment can ensure that the received switch state configuration signal is not caused by a mis-triggering by the vehicle user. For example, the frame number threshold is 3 frames. This judgment can ensure that the signal is valid only when more than 3 frames of messages are received.

In one example, referring to block 2042, the judgment module 52 judges whether an error has occurred during the transmission and storage of each frame of the message. This judgment can be achieved through a variety of information integrity and correctness verification methods, for example, a cyclic redundancy check (CRC).

This judgment can ensure that there are no errors in the information contained in the received switch state configuration signal during the transmission and storage process, i.e., ensure the integrity and correctness of the information contained in the received switch state configuration signal.

In one example, referring to block 2043, the judgment module 52 judges if the field included in each frame of the message that represents the receiving object of the message matches a predetermined field. For example, each frame of the message contains the following field: the unique identifier (ID) of the sending object of the message. the predetermined field is, for example, a value of the ID of the sending object represented in binary.

In examples of the present invention, the sending object is the airbag control unit 50, i.e., the field representing the receiving object of the message should be the ID of the airbag control unit 50. In this way, the predetermined field is set to the value of the ID of the airbag control unit 50 represented in binary. This judgment is achieved by judging whether the value of the field representing the ID of the receiving object in each frame of the message is equal to the value of the predetermined field.

This judgment can ensure that the received switch state configuration signal is indeed a signal sent to the airbag control unit 50, rather than a signal sent to other control units of the vehicle, improving the reliability of the decision regarding the state configuration of the switch 10 in this regard.

In one example, referring to block 2044, the judgment module 52 determines whether the values of the switch states representing the requests in each frame of the message are equal. For example, the ON state of the switch 10 is represented by a first value (e.g., binary 1) and the OFF state of the switch 10 is represented by a second value (e.g., binary 0). In the user's one-time switch state configuration, it is reasonable that the switch state values contained in each frame of the message are equal. If an inequality occurs, it means that different switch states are requested in one switch configuration. The reason for this unreasonable situation may be that the signal was tampered with during transmission or storage.

This judgment can ensure that the switch states requested to be configured in all message frames are consistent, thereby improving the reliability of the decision on the state configuration of the switch 10 in this respect.

According to embodiments of the present invention, the above plurality of judgments can be executed in the order described above, i.e., when the result of one judgment is affirmative, the next judgment is executed. The received switch state configuration signal is determined to be invalid once the result of a certain judgment is negative.

According to examples of the present invention, the above plurality of judgments may also be executed simultaneously or in an order different from the order described above.

According to examples of the present invention, another implementation of the above plurality of judgments is: the judgment module 52 first judges whether the number of message frames corresponding to the received switch state configuration signal is greater than or equal to the frame number threshold (block 2041). If the result of this judgment is affirmative, the judgment module 52 selects a message with a predetermined number of frames from the received multi-frame messages and executes the judgment of blocks 2042-2044 above for each frame of the selected message frames. Here, the judgment of execution blocks 2042-2044 may be performed in any order or at the same time. The advantage of this embodiment is that when a large number of message frames are received, it can save judgment time while ensuring the reliability of the judgment.

In this embodiment, the predetermined number of frames may be predetermined based on user needs or specific application scenarios as well as in-vehicle communication testing and/or model calculations and may be stored in the judgment module 52. Moreover, the predetermined number of frames is adjustable. In addition, the step of selecting a message with a predetermined number of frames from the received multi-frame messages may be implemented as follows: selecting a message with a predetermined number of continuous frames from the multi-frame messages; or selecting a message of predetermined number of intermittent (i.e., discontinuous) frames from the multi-frame messages.

The basis for selecting messages with a predetermined number of continuous or discontinuous frames may be message type. For example, messages with a predetermined number of frames are selected from the multi-frame messages according to a predetermined message type and the message frames of this type may appear continuously or intermittently in the multi-frame messages.

The basis for selecting messages with the predetermined number of continuous or discontinuous frames may also be the position of the message frame in the multi-frame message. For example, a message with a predetermined number of frames located in the head or tail of the multi-frame messages is selected. In this case, continuous message frames in the head or tail may be selected. For example, messages with a predetermined number of frames located in the middle part of the multi-frame messages are selected. In this case, continuous or discontinuous message frames in the middle part may be selected.

The method 200 proceeds to block 206 when the determination result in block 204 is that the switch state configuration signal is valid. In block 206, the control module 53 controls the ignition circuit associated with the anti-rollover function according to the switch state requested in the switch state configuration signal.

In one example, referring to block 2061, when the switch state of the requested configuration is ON, the control module 53 controls the ignition circuit associated with the anti-rollover function to prohibit the corresponding safety component (such as a safety component such as an airbag) from being deployed.

In this case, even if the conditions for deploying the corresponding safety components are met, they will not be deployed because the control module 53 suppresses the deployment based on the configuration of the switch 20.

In this case, the vehicle event data recording module 54 records a deployment failure event.

In this case, if the communication module 51 receives a sensor signal indicating that the vehicle is about to experience an event more dangerous than rollover, the control module 53 controls the ignition circuit associated with the anti-rollover function to allow corresponding safety components (such as airbags) to be deployed. Events that are more dangerous than rollover include vehicle collision events, such as head-on collisions or side collisions. The collision event may be determined based on detection information from a sensor. For example, the collision event may be determined based on parameters output by an acceleration sensor and/or an inertial sensor (not shown).

In another example, referring to block 2062, when the switch state of the requested configuration is OFF, the control module 53 controls the ignition circuit associated with the anti-rollover function to permit the corresponding safety component (such as an airbag) to be deployed.

In this case, once the conditions for deploying the corresponding safety components are met, they will be deployed because the control module 53 permits the deployment based on the configuration of the switch 20.

The method 200 proceeds to block 208 when the determination result in block 204 is that the switch state configuration signal is invalid. In block 208, the control module 53 controls the ignition circuit associated with the anti-rolling function according to the switch state requested to be configured in the last valid switch state configuration signal in the current ignition cycle of the vehicle. For example, if the switch state requested to be configured in the last valid signal is ON, the corresponding safety component is prohibited from being deployed. Conversely, if the switch state requested to be configured in the last valid signal is OFF, the corresponding safety component is permitted to be deployed.

In block 210, in the event that the switch state configuration signal is determined to be invalid, the control module 53 determines the penalty time according to the result of one or more of the above plurality of judgments. In this case, penalty time refers to: in the event that the switch state configuration signal is determined to be invalid, the delay time for the anti-rollover function suppression switch 20 to be configured again (i.e., to receive a state configuration request again). For example, the switch 20 may be displayed in gray on the HMI 10 to express to the vehicle that the switch 20 is in a non-configurable state until after the penalty time has passed and the switch 20 can be configured again, at which time the switch 20 may no longer be displayed in gray.

In one example, if the judgment result of the above block 2042 or 2043 is negative two or more times in succession, that is, if the following appears two or more times in succession: If an error occurs during the transmission and storage of the message or if a field in the message indicating the receiving object of the message does not match a predetermined field, the penalty time is determined as the first delay duration. If the judgment result of the above block 2044 is negative two or more times in succession, that is, if the following appears two or more times in succession: If the values of the switch states indicated by the requests in the multi-frame messages are not equal, the penalty time is determined as the second delay duration. Furthermore, the first delay duration is greater than the second delay duration. For example, the first delay duration is 10 s, i.e., the user needs to wait 10 seconds to configure the switch 20 again; the second delay duration is 3 s, i.e., the user needs to wait 3 seconds to configure the switch 20 again.

At block 212, the control module 53 generates a return signal including information such as: the judgment result of whether the switch state configuration signal is valid. The return signal also contains the following information when the signal is judged invalid: the penalty time calculated in block 210.

In block 214, the communication module 51 sends the return signal to the HMI control unit 30 to present to the user on the HMI 10 information as to whether the switch state configuration signal is valid, and, optionally, the penalty time.

In block 216, the control module 53 controls the indicator light 40 to present the current state of the switch 20, such as the ON, OFF, or non-configurable state of the switch 20, using a predetermined light color and/or a predetermined blinking pattern.

It will be understood that while blocks 208-216 are introduced in the above order and are shown in a sequential manner in FIG. 2, blocks 208-216 may be executed simultaneously or in an order different from that described above according to examples of the present invention.

In addition, according to examples of the present invention, the method 200 may further comprise a control process of judging whether the current scenario is a scenario suitable for suppressing the anti-rollover function based on the scenario signal. Examples of this control process are described below.

In one example, the communication module 51 receives a scenario signal. The scenario signal contains information representing the current driving scenario of the vehicle. The control module 53 then judges whether the current driving scenario is one of a predetermined one or more scenarios suitable for suppressing the anti-rollover function. When the judgment result is negative, the control modules 53 generates a control instruction for disabling the anti-rollover function suppression switch.

Examples of the present invention provide a machine-readable storage medium having executable instructions stored thereon that, when executed, cause one or a plurality of processors to perform the method 200 described above.

Examples of the present invention provide a computer program product having computer-executable instructions stored thereon that, when executed, cause one or a plurality of processors to perform the method 200 described above.

It should be understood that all operations in the above-described methods are merely exemplary, and the present disclosure is not limited to any operations or the sequence of these operations in the methods but should encompass all other equivalent transformations under the same or similar concepts.

It should be noted that the processor may use any combination of one or more of: an appropriate central processing unit, CPU, multiprocessor, single-chip microcomputer, digital signal processor, DSP, application-specific integrated circuit, etc., capable of executing software instructions of a computing program stored in memory. Accordingly, the memory may be considered as part of or form part of the computer program product. The processor may be configured to execute a computer program stored therein to cause the controller to perform the required steps.

It should be understood that software may be broadly construed as representing instructions, instruction sets, codes, code segments, program codes, programs, subprograms, software modules, applications, software applications, software packages, routines, subroutines, objects, execution threads, processes, functions, and the like. Software may reside on computer-readable media. Computer-readable media can include, for example, storage devices such as magnetic storage devices (e.g., hard drives, floppy disks, magnetic tapes), optical disks, smart cards, flash devices, random-access memory (RAM), read-only memory (ROM), programmable ROM (PROM), erasable PROM (EPROM), electrically erasable PROM (EEPROM), registers, or removable disks. Although memory is depicted as being separate from the processor in several aspects provided in the present disclosure, memory may also be located within the processor (e.g., cache or registers).

The above description is provided to enable any skilled person in the art to implement various aspects described in this document. Various modifications of these aspects are apparent to those skilled in the art, and the general principles defined herein may apply to other aspects. Accordingly, the claims are not intended to be limited to the aspects illustrated herein. Equivalency transforms in all structures and functions of elements described in the various aspects of the present disclosure known to, or about to become known to, those skilled in the art will be expressly included herein by reference and are intended to be covered by the claims.

1. An airbag control unit, comprising:
a communication module configured to receive a switch state configuration signal including a configuration request for a switch state of an anti-rollover function suppression switch of an anti-rollover function;
a judgment module configured to judge a validity of the switch state configuration signal; and
a control module configured to control an ignition circuit associated with the anti-rollover function according to the switch state requested to be configured in the switch state configuration signal when the judgment module determines that the switch state configuration signal is valid.

2. The airbag control unit of claim 1, wherein the ignition circuit associated with the anti-rollover function comprises an airbag ignition circuit.

3. The airbag control unit of claim 1, wherein controlling the ignition circuit associated with the anti-rollover function according to the switch state requested to be configured in the switch state configuration signal comprises:
when the configuration request of the switch state is an ON state, the ignition circuit associated with the anti-rollover function is controlled to prohibit deployment of safety components,
wherein the safety components include such as airbags.

4. The airbag control unit of claim 3, wherein controlling the ignition circuit associated with the anti-rollover function according to the switch state requested to be configured in the switch state configuration signal comprises:
when the configuration request of the switch state is an OFF state, the ignition circuit associated with the anti-rollover function is controlled to permit deployment of the safety components.

5. The airbag control unit of claim 1, wherein:
the airbag control unit comprises a vehicle event data recording module configured to record a deployment failure event in an event that conditions for deploying safety components are satisfied and deployment of the safety components is suppressed, and
the safety components include airbags.

6. The airbag control unit of claim 1, wherein the communication module is configured to receive a scenario signal including information representing a current driving scenario of a vehicle; and
the control module is configured to:
determine a judgment result indicating whether the current driving scenario is one of a predetermined one or more scenarios suitable for suppressing the anti-rollover function; and
when the judgment result is negative, generate a control instruction for disabling the anti-rollover function suppression switch.

7. The airbag control unit of claim 1, wherein judging the validity of the switch state configuration signal comprises one or more of the following judgments;
when results of each judgment are affirmative, the judgment module determines that the switch state configuration signal is valid, and when the result of at least one judgment is negative, the judgment module determines that the switch state configuration signal is invalid;
judging whether a the number of message frames corresponding to the received switch state configuration signal is greater than or equal to a frame number threshold;
judging whether errors have occurred during a transmission and storage of each frame of the message;
judging whether a field representing a receiving object of each frame of the message matches a predetermined field; and
judging whether the values of the switch states representing requests in each frame of the message are equal.

8. The airbag control unit of claim 1, wherein judging the validity of the switch state configuration signal comprises:
determining a judgment result indicating whether a number of message frames corresponding to the received switch state configuration signal is greater than or equal to a frame number threshold;
when the judgment result is affirmative, a message with a predetermined number of frames is selected from received multi-frame messages and one or more judgments are performed on the selected message frame;
when the results of each judgment are affirmative, the judgment module determines that the switch state configuration signal is valid, and when the result of at least one judgment is negative, the judgment module determines it is judged that the switch state configuration signal is invalid:
judging whether errors have occurred during the transmission and storage of each frame of the message;
judging whether a field representing a receiving object of each frame of the message matches a predetermined field; and
judging whether the values of the switch states representing requests in each frame of the message are equal.

9. The airbag control unit of claim 7, wherein the control module is configured to:
determine a penalty time when the judgment module determines that the switch state configuration signal is invalid,
wherein the penalty time refers to when the judgment module determines the switch state configuration signal to be invalid, a delay duration after which the anti-rollover function suppression switch can be configured again.

10. The airbag control unit of claim 9, wherein determining the penalty time comprises:
when a judgment result occurs two or more times in succession, the penalty time is determined as a first delay duration, wherein an error occurs during the transmission and storage of the message or a field in the message indicating the receiving object of the message does not match a predetermined field;
when a judgment result occurs, the penalty time is determined as a second delay duration, wherein values of the switch states indicated by requests in multi-frame messages are not equal;
wherein the first delay duration is greater than the second delay duration.

11. The airbag control unit of claim 1, wherein the control module is configured to control an ignition circuit associated with the anti-rollover function according to the switch state requested to be configured in a last valid switch state configuration signal in a current ignition cycle of a vehicle when the judgment module determines it is determined that the switch state configuration signal is invalid.

12. The airbag control unit of claim 1 any of claims 1-11, wherein the control module is configured to release a suppression of deployment of safety components including airbags when the deployment of the safety components including airbags is suppressed when if the communication module receives a sensor signal indicating that the a vehicle is about to experience an event more dangerous than rollover. Optionally, events that are more dangerous than rollover include vehicle collision events.

13. The airbag control unit of claim 1, wherein the control module is configured to:
generate a return signal, which includes a judgment result of whether the switch state configuration signal is valid, and when the judgment result is that the switch state configuration signal is invalid, the return signal also includes a penalty time,
wherein, the penalty time refers to when the switch state configuration signal is determined to be invalid, a delay duration after which the anti-rollover function suppression switch can be configured again.

14. An airbag system for a vehicle, comprising:
a human-machine interface;
the an anti-rollover function suppression switch; and
the airbag control unit of claim 1.

15. The airbag system of claim 14, wherein the anti-rollover function suppression switch is configured as one of (i) an operable virtual button capable of being presented on the human-machine interface, (ii) an operable physical switch and (iii) a smart switch that is automatically configured.

16. The airbag system of claim 14, further comprising:
an indicator light configured to indicate a current state of the anti-rollover function suppression switch by blinking state and/or light color state.

17. The airbag system of claim 14, further comprising:
a sensor configured to detect parameters capable of indicating whether the vehicle is about to experience a collision event.

18. A method for controlling an airbag system, comprising:
receiving a switch state configuration signal including a configuration request for a switch state of an anti-rollover function suppression switch;
judging a validity of the switch state configuration signal; and
controlling an ignition circuit associated with an anti-rollover function according to the switch state requested to be configured in the switch state configuration signal when it is determined that the switch state configuration signal is valid.

19. A non-transitory machine-readable storage medium having executable instructions stored thereon that, when executed, cause one or a plurality of processors to perform the method according to claim 18.

20. The method of claim 18, wherein a computer program product includes computer-executable instructions that, when executed, causes one or a plurality of processors to perform the method.
